(19) United States
(12) Patent Application Publication
(10) Pub. No.: US 2008/0152139 A1
(43) Pub. Date: Jun. 26, 2008

(54) APPARATUS, AND ASSOCIATED METHOD, FOR COMMUNICATING PUSH MESSAGE PURSUANT TO PUSH MESSAGE SERVICE

(75) Inventors: GERHARD DIETRICH KLASSEN, WATERLOO (CA); MICHAEL HUNG, TORONTO (CA); MICHAEL STEPHEN BROWN, KITCHENER (CA); HERB LITTLE, WATERLOO (CA)

Correspondence Address: DOCKET CLERK, PO BOX 12608, DALLAS, TX, 75225, US

(73) Assignee: RESEARCH IN MOTION LIMITED, WATERLOO, ON (CA)

(21) Appl. No.: 11/960,969

(22) Filed: Dec. 20, 2007

Related U.S. Application Data
(60) Provisional application No. 60/871,635, filed on Dec. 22, 2006.

(51) Int. Cl. H04L 9/32; H04K 1/00

(52) U.S. Cl. 380/247; 380/270

(57) ABSTRACT

Apparatus, and an associated method, for a mobile station, or other radio communication device, operable pursuant to an instant message, or other push message, service. Prior to effectuation of the communications pursuant to the service, the mobile station logs-in. The log-in utilizes encrypted log-in information pursuant to a log-in procedure, e.g., keys are exchanged between the mobile station and a communication network. The network approves the log-in of the mobile station, and admits the mobile station. A detector at the mobile station detects the admittance. Subsequently, messages are generated and sent and received pursuant to the instant message, or other push message, service.

### CROSS REFERENCE TO RELATED APPLICATIONS

The present invention claims the priority of provisional patent application No. 60/871,635, filed on Dec. 22, 2006.

The present invention relates generally to a manner by which to communicate a push message, such as an instant message, pursuant to a push message service. More particularly, the present invention relates to apparatus, and an associated method, by which to perform the push message service. A radio communication device, such as a mobile station, is first logged-in through the exchange of encrypted information. Thereafter the radio communication device communicates the push messages in unencrypted form.

By encrypting the information exchanged during log-in, its security is ensured. And, by sending subsequent messages in unencrypted form, processing needs, and time delays caused by increased processing needs, are avoided. Additionally, issues pertaining to governmental licensing and regulatory requirements related to data encryption are minimized.

### BACKGROUND OF THE INVENTION

Use of mobile communication systems through which to communicate is pervasive in modern society. Use of mobile communication systems not only provides increased communication mobility but sometimes further also provides for the ability to communicate when wireline communications would not be possible or practical. A cellular communication system is an exemplary type of mobile communication system. The network infrastructures of various types of cellular communication systems have been developed and deployed, permitting communications to be effectuated therethrough. Significant portions of the populated areas of the world are encompassed by the network infrastructures of one or more cellular communication systems. Analogous types of radio communication systems have also been developed and deployed, some of which provide for interoperability with mobile stations, portable radio transceivers, usually of dimensions permitting their carriage by users, are typically used through which to communicate with a corresponding network infrastructure, cellular or otherwise, in whose coverage area that the mobile station is positioned and with which the mobile station is technically compatible.

Cellular communication systems, for the most part, were first used primarily to effectuate voice communications. While cellular communication systems continue regularly to be used for telephonic communications, mobile stations are increasingly used pursuant to data services. Data services effectuated by way of a mobile station include message-related services, both store-and-forward message services and push-message services. A data message may be short, formed of merely a small number of alphanumeric characters or may be quite lengthy, including a lengthy string of text and a large data attachment.

When a messaging service, or other data service, is performed in a cellular, or other mobile, communication system, dual advantages of communication mobility and communication flexibility are provided.

An instant messaging service is a type of push message service. In an instant message service, two or more parties exchange text messages that are pushed to a destination, or destinations. Seemingly almost-instantaneous communication of text messages is provided. Two or more parties are able to thereby exchange text-based messages to carry out a two-way, or greater, conversation or “chat”. When instant messaging is provided at a mobile station, an instant-messaging chat can be carried out between a set of mobile stations when the users thereof are positioned at almost any location within the coverage area of a cellular communication system.

A user of a mobile station in a cellular communication system is generally provided access to the communication system pursuant to a subscription or otherwise pursuant to payment of a fee to an operator of the system. Different subscriptions and billing rates are sometimes provided for voice and data communications. Sometimes, depending on the locations at which the users are positioned, and the communication networks with which the mobile stations operated by the users are positioned when communications are to be carried out, data communication services are less expensive than those carried out by voice services. For instance, if the users of the mobile stations are positioned in different nations, the costs associated with an international call are sometimes relatively expensive. Communication of a text message, such as that carried out pursuant to an instant message service, might well be considerably less expensive, while providing for the conveyance of the same information. For any of various reasons, therefore, including cost reasons, communication by way of an instant messaging service is sometimes preferred.

While in some conventional text messaging schemes, encryption is performed to maintain the security of the communications, various governmental regulations and licensing requirements are in place. That is to say, governmental entities sometimes place limitations on the transfer of encryption technology.

There is a need, therefore, to maintain security of access to a cellular communication system but to provide for text messaging services, such as instant messaging services, that are not violative of governmental regulations.

Additionally, encryption techniques are typically somewhat computationally complex, require time to carry out the encryption and decryption operations, and generally require the use of SSL (secure socket layer) certificates. There is additionally a need to provide for text messaging services that permit their performance with reduced computational complexity.

It is in light of this background information related to push message services that the significant improvements of the present invention have evolved.

### BRIEF DESCRIPTION OF THE DRAWINGS

FIG. 1 illustrates a functional block diagram of a communication system in which an embodiment of the present invention is operable.

FIG. 2 illustrates a sequence diagram representative of exemplary signaling generated pursuant to operation of an embodiment of the present invention.

FIG. 3 illustrates a method flow diagram representative of the method of operation of an embodiment of the present invention.

### DETAILED DESCRIPTION

The present invention, accordingly, advantageously provides apparatus, and an associated method, by which to communicate a push message, such as an instant message, communicated pursuant to a push message service.

Through operation of an embodiment of the present invention, a manner is provided by which to perform log-in of a radio communication device, such as a cellular, or other mobile station, through the exchange of encrypted information. Upon authentication, or other acceptance of the mobile station, messages communicated by the mobile station are communicated in unencrypted form.

Security of the log-in information is secured as the information is encrypted prior to its communication. And, as the push messages are communicated by the mobile station in unencrypted form, processing and time resources, otherwise needed to encrypt, and decrypt, the push messages are minimized.

In one aspect of the present invention, a push message service is initiated at a mobile station by, e.g., selection by a user of the mobile station to initiate the service. When selection is made, a key exchange procedure is carried out. That is to say, a public key of the mobile station is communicated by the mobile station and a key associated with a communication node of the network is communicated to the mobile station. The public key of the mobile station is made known, thereby, to the communication node of the network. And, the public key of the mobile station is used to encrypt log-in information used by the mobile station to log-in pursuant to the push message service.

In another aspect of the present invention, the log-in information that is encrypted is formed of a user name and a password associated with the user name. Because the password is encrypted, its security is ensured. Detection of the password, when communicated upon a non-secure communication path is prevented as the encryption prevents a usurper from detecting the password.

In another aspect of the present invention, the mobile station detects grant of access of the mobile station to communicate pursuant to the push message service. The grant, and network-generated grant is communicated in encrypted, or unencrypted, form. If the grant is communicated in encrypted form, the mobile station de-encrypts the received information and ascertains the grant of the access therefrom. Commencement of sending of a push message follows.

In another aspect of the present invention, the mobile station sends an encrypted log-in message, including a user name and password, in encrypted form, and, once authenticated, the mobile station is available to receive a push message, initiated elsewhere. Subsequent to the log-in by the mobile station, push messages generated by the mobile station are sent in unencrypted form.

In another aspect of the present invention, the network-based communication node with which the mobile station directly communicates comprises a push-message proxy server. The key exchange between the mobile station and the network-based communication node are carried out between the proxy server and the mobile station. The proxy server, for instance, is connected to a packet data network, such as the internet. Subsequent to the exchange of keys, the mobile station logs-in with the proxy server, using encrypted log-in information, encrypted using the key provided to the mobile station. Upon authentication of the mobile station, the mobile station is permitted to participate pursuant a push message service.

In another aspect of the present invention, the proxy server forms an SSL (secure socket link) with the push message server while communications between the mobile station and the proxy server do not use SSL procedures. Signaling overhead, processing and time constraints, and other issues pertaining to the communication of push messages in encrypted form are obviated as the messages are communicated in unencrypted form in the radio access network, and by way of a radio air interface with the mobile station.

Because encryption is used in the communication of the log-in information, e.g., the password, detection of the password during its communication on the radio air interface is practically infeasible. And, subsequent to authentication of the mobile station, a subsequently generated push message, formed at the mobile station, is sent in unencrypted form by way of the radio air interface and the radio access network to the proxy server. At the proxy server, the push message is forwarded on, pursuant to a secured sockets link procedure to the push message server. And, then, the push message is forwarded on, in a desired manner, to an ultimate communication endpoint. If the communication endpoint forms another mobile station, the push message is forwarded, e.g., in unencrypted form. Or, the push message is forwarded on in another manner.

In these and other aspects, therefore, apparatus, and an associated method, is provided for a radio communication device operable to communicate a push message pursuant to a push message service. An encryptor is adapted to receive log-in information used by the radio communication device pursuant to log-in of the radio communication device. The encryptor is configured to encrypt the log-in information prior to communication thereof. A log-in acceptance detector is adapted to receive indication of log-in acceptance of the radio communication device. A message operator is configured to operate upon the push message subsequent to reception by the log-in acceptance detector of the log-in acceptance. The push message is communicated in unencrypted form.

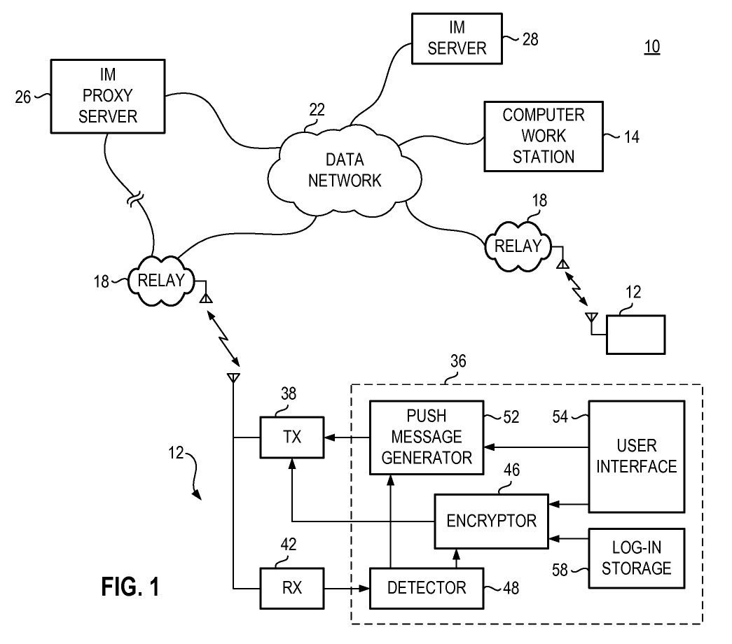

Turning first therefore, to FIG. 1, a radio communication system, shown generally at 10, provides for communications with wireless devices, here radio stations 12. In the exemplary implementation, the communication system includes a radio part forming a cellular communication network. More generally, the radio part of the communication system is representative of any of various radio communication systems in which communications are carried out making use of a radio communication link with a wireless transceiver.

In the exemplary implementation, the mobile stations are capable of forming communication endpoints of an instant messaging (IM) or other push message service. The instant messaging service provides for the pushing of messages and other data, to a communication endpoint. In a typical instant messaging service, text messages, and files, are pushed, or otherwise communicated, between the communication endpoints. An instant message service is created, for instance, between a set of mobile stations 12. Or, the instant message service is created between a mobile station 12 and a network-connected device, such as a computer workstation 14. While the instant message services shown herein are between a pair of communication endpoints, more generally, the instant message service is creatable between a greater number of communication endpoints.

The network part of the communication system includes a data relay 18 and a data network 22. The communication system 10 here shows separate data relays 18, each connected to the data network 22. The data network is representative of, e.g., the internet.

Any of various entities are connectable to the data network. Here, in addition to the computer work station 14, instant messaging, or other push message, servers 26 and 28 are shown to be connected to the core network. The proxy server is also shown to be connected to a data relay 18. The server 26 forms a proxy server, i.e., a proxy to the server 28. The servers form communication nodes between, and through, which the messages generated during a push message service are communicated. During regular operations, data is communicated between the servers 26 and 28, using an SSL (secure socket layer) protocol.

As noted previously, for any of various reasons, there is a desire not to communicate messages to the radio access network, or a data relay thereof, and over the radio air interface in encrypted form. However, for purposes of authenticated access to the push message proxy server, the log-in information of the mobile station 12 must be communicated in encrypted form. Accordingly, pursuant to an embodiment of the present invention, the mobile station 12 includes apparatus 36 of an embodiment of the present invention. The apparatus is formed of functional entities, implementable in any desired manner, including by algorithms executable by processing circuitry. While the apparatus is shown to be connected to transceiver circuitry, represented by a transmit part 38 and a receive part 42 of the mobile station, functional entities of the apparatus, in various implementations, are implemented as part of the transceiver circuitry of the mobile station. Other parts, for instance, are implemented at a control element of the mobile station.

Here, the apparatus 36 includes an encryptor 46, a detector 48, a push message operator 52, a user interface 54, and a log-in data storage element 58.

In operation, election is made, here through user actuation of the user interface 54, to engage in, or perform, a push message service, here an instant messaging service. The user inputs, or causes to be retrieved from the log-in storage element 58, log in information that is applied to the encryptor 62. The log-in information comprises, e.g., both a user name and a password. The encryptor operates to encrypt the log-in information and to provide the information, once encrypted, to the transmit part 38 of the transceiver circuitry. The transmit part causes the encrypted log-in information to be communicated, by way of the radio air interface and the radio access network to be delivered to the proxy server. Appropriate formatting, packetizing, and encapsulation is provided by the transmit part so that the log-in information is delivered to the proxy server.

Preliminary to operation, an exchange of keys is carried out between the mobile station and the proxy server. The exchange is carried out, e.g., automatically or by initiation by a user of the mobile station to appropriate actuation of the user interface 54. The public key downloaded to the mobile station is received at the receive part 42, detected by the detector 48, and provided to the encryptor 46. The key is used pursuant to encryption operations by the encryptor. In other implementations, other manners by which to encrypt the log-in information are instead utilized.

The proxy server utilizes the received, log-in information to authenticate the mobile station access to the proxy server pursuant to the instant messaging, or other push message, service. The server deencrypts the encrypted information, analyzes the information, and, if appropriate, approves authentication of the mobile station. A response is returned to the mobile station. In one implementation, the authentication acknowledgement is returned in encrypted form, necessitating the de-encryption at the mobile station.

Upon detection of the authentication, and grant of access, of the mobile station pursuant to the push message service, the mobile station is permitted to participate pursuant to an instant messaging, or other push message, service.

When a user of the mobile station elects to send the message pursuant to the push message service, appropriate entry is made by way of the user interface, and such inputs cause the push message operator 52 to generate a push message for application to the transmit part 38 of the transceiver circuitry. The transmit part causes the push message to be transmitted, in unencrypted form, by way of the radio air interface for delivery to the relay associated with a radio access network. Once received at the radio access network, the push message is routed therethrough and provided to the proxy server 26. The proxy server, in turn, utilizing the SSL procedure, forwards the push message onto the server 28. And, in turn, the server 28 routes the push message on to the ultimate, communication endpoint, such as the computer workstation 14, or another mobile station 12. If the communication endpoint forms another mobile station, the forwarding is carried out, for instance, by way of a proxy server associated with the endpoint mobile station.

Thereby, the security of the log-in procedures of the mobile station pursuant to the push message service are maintained while permitting the push messages to be communicated in unencrypted form.

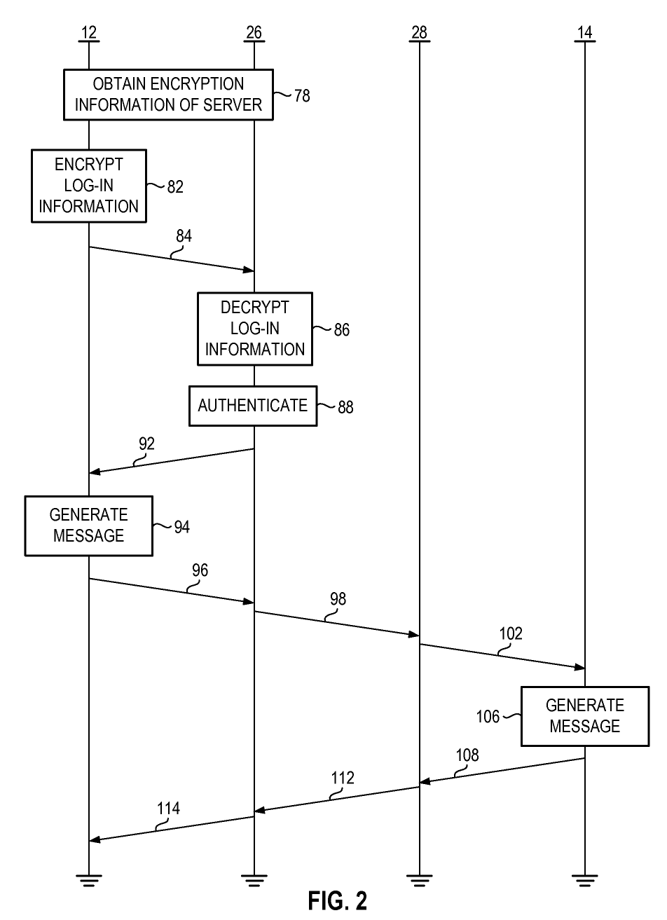

FIG. 2 illustrates a message sequence diagram representative of signaling generated during operation of an embodiment of the present invention, such as that implanted in the exemplary system shown in FIG. 1. The message sequence diagram, shown generally at 74, while representative of signaling in the communication system 10 shown in FIG. 1 is, more generally, representative of signaling generated pursuant to a push message service carried out with a mobile station operable in other types of radio communication systems.

Here, prior to performance of a push message service, the mobile station obtains, indicated by the block 78, encryption information related to a network communication node, here the proxy server 26. The encryption information comprises, for instance, a public key of the proxy server. And, the public key is provided pursuant to a key exchange between the mobile station and the proxy server.

Once the encryption information is obtained, the information is stored at the mobile station, or otherwise maintained, ready for use pursuant to implementation and performance of the instant messaging, or other push message, service. Upon commencement of the push message service, the encryption information is used to encrypt, indicated by the block 82, log-in information of the mobile station, needed to be granted access to communicate pursuant to the push message service, is encrypted. The encryption is performed using the encryption information obtained from the network communication node. The encrypted log-in information, e.g., the user name and password associated with the mobile station, is sent, indicated by the segment 84, and delivered to the proxy server by way of the radio air interface and the relay entity associated with a radio access network. Once delivered to the proxy server, the log-in information is deencrypted, indicated by the block 86. And, authentication is performed, indicated by the block 88. If the log-in information is valid, the mobile station is authenticated, and access of the mobile station to communicate pursuant to the push message service is granted. The grant is communicated, indicated by the segment 92, to the mobile station. The mobile station is alerted thereby of the grant of access made thereto. Subsequently, a push message is generated, indicated by the block 94, at the mobile station and communicated, indicated by the segment 96, to the proxy server 26. The proxy server, in turn, forwards, indicated by the segment 98, the message on to the push message server 28. And, the server 28, in turn, forwards, indicated by the segment 102, the push message to the communication endpoint, here for purposes of example, the computer workstation 14. The endpoint is here further shown to generate, indicated by the block 106, a push message that is communicated to the mobile station in reverse direction, indicated by the segments 108, 112, and 114. In the exemplary implementation, the routing of the information between the servers 26 and 28 is performed pursuant to SSL procedures. Segments 98 and 112 are communicated at the SSL or pursuant to SSL procedures. In one implementation, SSL procedures are further utilized between the server 28 and the communication endpoint, such signaling represented by the segments 102 and 108.

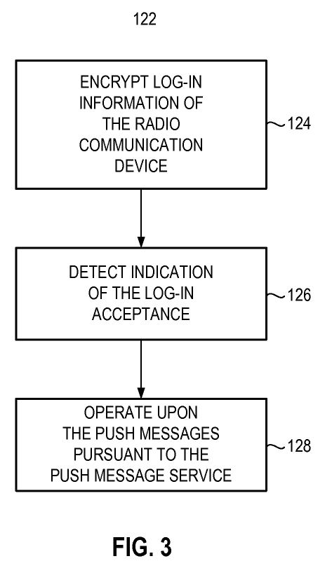

FIG. 3 illustrates a method flow diagram shown generally at 122, representative of the method of operation of an embodiment of the present invention. The method is for communicating a push message pursuant to a push message service.

First, and as indicated by the block 124, log-in information used by the radio communication device pursuant to its log-in is encrypted. Then, and as indicated by the block 106, the radio communication device detects indication of log-in acceptance of the radio communication device pursuant to instant messaging service.

Subsequently, and as indicated by the block 128, a push message is operated upon. The push message is in unencrypted form. Send messages are sent by the radio communication device in unencrypted form, and received messages are received at the radio communication device in unencrypted form.

Because the push messages, such as instant messages, are communicated in unencrypted form, issues associated with use of encryption, including regulatory compliance and processing capacities and time delays associated with encryption are avoided.

The previous descriptions are of preferred examples for implementing the invention, and the scope of the invention should not necessarily be limited by this description. The scope of the present invention is defined by the following claims.

What is claimed is:

1. Apparatus for a radio communication device operable to communicate a push message pursuant to a push message service, said apparatus comprising:
an encryptor adapted to receive log-in information used by the radio communication device pursuant to log-in of the radio communication device, said encryptor configured to encrypt the log-in information prior to communication thereof;
a log-in acceptance detector adapted to receive indication of log-in acceptance of the radio communication device; and
a message operator configured to operate upon the push message subsequent to the reception by said log-in acceptance detector of the log-in acceptance, the push message communicated in unencrypted form.

2. The apparatus of claim 1 wherein the log-in information that said encryptor in adapted to receive comprises an encryption key.

3. The apparatus of claim 1 wherein the log-in information that said encryptor is adapted to receive comprises an identifier that identifier the radio communication device.

4. The apparatus of claim 1 wherein the log-in information encrypted by said encryptor comprises exchange information exchanged pursuant to a hand-shake procedure.

5. The apparatus of claim 1 wherein the indication of the log-in acceptance detector comprises exchange information exchanged pursuant to a hand-shake procedure.

6. The apparatus of claim 1 wherein said message operator comprises a message sender configured to send the push message, in un-encrypted form, subsequent to reception of the log-in acceptance by said log-in acceptance detector.

7. The apparatus of claim 6 further comprising a selector configured to select whether to encrypt the push message, said message sender configured to send the push message, in the un-encrypted form, responsive to selection by said selector to send the push message in the un-encrypted form.

8. The apparatus of claim 1 wherein said message operator comprises a message receiver configured to receive the push message, in un-encrypted form, subsequent to reception of the log-in acceptance by said log-in acceptance detector.

9. The apparatus of claim 1 wherein the push message service comprises an instant message service, wherein the push message comprises an instant message, wherein the radio communication device comprises a mobile station, and wherein said encrypted encrypts the log-in information pursuant to registration of the mobile station.

10. The apparatus of claim 1 wherein the indication of the log-in acceptance received by said log-in acceptance detector comprises an indication of a network-generated log-in acceptance.

11. The apparatus of claim 1 wherein the log-in information received by said encryptor and the log-in acceptance, the indication of which is detected by said log-in detector, are generated pursuant to a generic message key exchange.

12. A method for communicating a push message pursuant to a push message service, said method comprising the operations of:
encrypting, at a radio communication device, log-in information used by the radio communication device pursuant to log-in of the radio communication device;
detecting, at the radio communication device, indication of log-in acceptance of the radio communication device; and
operating upon a push message, subsequent to detection during said operation of detecting, the push message in unencrypted form.

13. The method of claim 12 wherein the log-in information encrypted during said operation of encrypting comprises an encryption key.

14. The method of claim 12 wherein the log-in information encrypted during said operation of encrypting comprises an identifier that identifies the radio communication device.

15. The method of claim 12 wherein the log-in information encrypted during said operation of encrypting and the log-in acceptance, the indication of which is detected during said operation of detecting, comprises an exchange of information pursuant to a handshake procedure.

16. The method of claim 12 wherein said operation of operating upon the push message comprises sending the push message, in un-encrypted form, subsequent to detection, during said operation of detecting, of the indication of the log-in acceptance.

17. The method of claim 12 wherein said operation of operating upon the push message comprises receiving the push message, in un-encrypted form, subsequent to detection, during said operation of detecting, of the indication of the log-in acceptance.

18. A method of communicating an instant message at a mobile station pursuant to an instant messaging service, said method comprising the operations of:
performing log-in procedures through the exchange of encrypted messages; and
communicating an instant message, in un-encrypted form, subsequent to successful completion of the log-in procedures.

19. The method of claim 18 wherein the exchange of encrypted messages made during said operation of performing the log-in procedures comprises exchange of encryption keys.

20. The method of claim 18 wherein said operation of communicating comprises sending the instant message, in un-encrypted form, by the mobile station.
